(19) United States
(12) Patent Application Publication
(10) Pub. No.: US 2025/0327706 A1
(43) Pub. Date: Oct. 23, 2025

(54) Spectrometer

(71) Applicant: THALES, Meudon (FR)

(72) Inventor: Nicolas TETAZ, CANNES LA BOCCA CEDEX (FR)

(21) Appl. No.: 19/176,158

(22) Filed: Apr. 11, 2025

(30) Foreign Application Priority Data
Apr. 18, 2024 (FR) 24 04039

(51) Int. Cl. G01J 3/02

(52) U.S. Cl. CPC G01J 3/0208; G01J 3/021

(57) ABSTRACT

A spectrometer including a slit suitable for receiving a light beam, a detector, a diffraction grating with at least one curvature, a collimating lens capable of sending the light beam from the slit onto the diffraction grating so as to obtain a plurality of diffracted beams, a deflecting mirror capable of reflecting the plurality of diffracted beams, and a focusing lens capable of receiving the plurality of reflected diffracted beams and focusing them on the detector, at least one optic, referred to as an optimized optic, from among the collimating lens, deflecting mirror, and focusing lens, so as to improve the image quality of the image generated by the detector from the plurality of diffracted beams.

### REFERENCE TO RELATED APPLICATION

This application is a U.S. non-provisional application claiming the benefit of French Patent Application No. 24 04039 filed on Apr. 18, 2024, the contents of which are incorporated herein by reference in their entirety.

### TECHNICAL FIELD OF THE INVENTION

The present invention relates to a spectrometer. The present invention also relates to an associated optical design method.

### BACKGROUND OF THE INVENTION

A spectrometer works on the following principle: a slit is placed at the focus of a collimator which images this slit ad infinitum. A disperser (prism or grating) spectrally separates the beam from the collimator, then an optical imager focuses these spectral beams onto a detector.

The difficulty lies in carrying out these various operations with sufficient image quality, but there are many optical solutions available. The compactness of the spectrometer is a major criterion: the aim is to be as compact as possible, particularly for airborne applications.

There are many different types of spectrometer, but the most compact optical solution to date is the Dyson spectrometer, an example configuration of which is shown in FIG. 1. As shown in FIG. 1, a Dyson spectrometer includes a slit F, a detector D, a single lens L and a grating R deposited directly on a power mirror. The single lens L is used in double-pass mode for the beam coming from the slit and those going to the detector. In recent years, Dyson's compactness has been further enhanced by the use of Freeform technology for the single lens and the grating.

However, creating the grating is complex, even more so if a freeform component is added to the grating substrate. In addition, integrating the detector close to the slit of the Dyson is mechanically complex. Finally, because of its configuration, a Dyson spectrometer is limited to a magnification of 1, which is restrictive for certain applications.

There is therefore a need for a spectrometer that is less complex to build and integrate mechanically, while remaining compact and offering good image quality.

### SUMMARY OF THE INVENTION

To this end, the aim of the invention is a spectrometer including:
a slit suitable for receiving a light beam,
a detector,
a diffraction grating with at least one curvature,
a collimating lens capable of sending the light beam from the slit onto the diffraction grating so as to obtain a plurality of diffracted beams,
a deflecting mirror capable of reflecting the plurality of diffracted beams, and
a focusing lens suitable for receiving the plurality of diffracted beams reflected by the deflecting mirror and for focusing the plurality of diffracted beams on the detector, at least one optic, known as an optimized optic, from among the collimating lens, deflecting mirror, and focusing lens, having been optimized so as to improve the image quality of the image generated by the detector from the plurality of diffracted beams.

In other beneficial aspects of the invention, the spectrometer includes one or more of the following features, taken in isolation or in any technically possible combination:
the collimating lens, the diffraction grating, the deflecting mirror and the focusing lens are the only optics of the spectrometer, and the diffraction grating is a reflection diffraction grating;
the or each optimized optic is a Freeform optic;
the spectrometer includes two optimized optics;
at least one optimized optic is the deflecting mirror;
at least one optimized optic is the focusing lens;
the collimating lens is a spherical lens;
the diffraction grating is spherical;
the collimating lens and the focusing lens have different powers so that the spectrometer's magnification is different from 1; and
the powers of both the collimating and focusing lenses are chosen so that the spectrometer's magnification is between 0.2 and 5.

The invention also relates to a method of optical design of a spectrometer as previously described, the method being computer-implemented using an optical design tool, the method including:
loading, into the optical design tool, a Dyson spectrometer including:
   a slit suitable for receiving a light beam,
   a detector,
   a diffraction grating with at least one curvature, and. a double-pass lens capable, on the one hand, of sending the light beam from the slit onto the diffraction grating so as to obtain a plurality of diffracted beams and, on the other hand, of focusing the plurality of diffracted beams onto the detector,
splitting the double-pass lens to obtain:
   a collimating lens capable of sending the light beam from the slit onto the diffraction grating to obtain a plurality of diffracted beams, and
   a focusing lens capable of focusing the plurality of diffracted beams onto the detector,
adding a deflecting mirror,
rearranging the collimating lens, focusing lens, and deflecting mirror so as to spatially separate the slit and the detector and so that the deflecting mirror is able to reflect the plurality of diffracted beams towards the focusing lens,
optimizing at least one optic, referred to as an optimized optic, from among the collimating lens, deflecting mirror, and focusing lens, so as to improve the image quality of the image generated by the detector from the plurality of diffracted beams, and
rearranging the slit, the detector, the diffraction grating, the collimating lens, the focusing lens and the deflecting mirror to obtain a mechanically adjustable spectrometer.

### BRIEF DESCRIPTION OF THE DRAWINGS

The invention will appear more clearly when reading the description that follows, given solely as a non-limiting example and made in reference to drawings in which:

FIG. 1 is an example of a Dyson spectrometer of the prior art, and

FIG. 2 is an example of a spectrometer according to the invention.

### DETAILED DESCRIPTION OF THE INVENTION

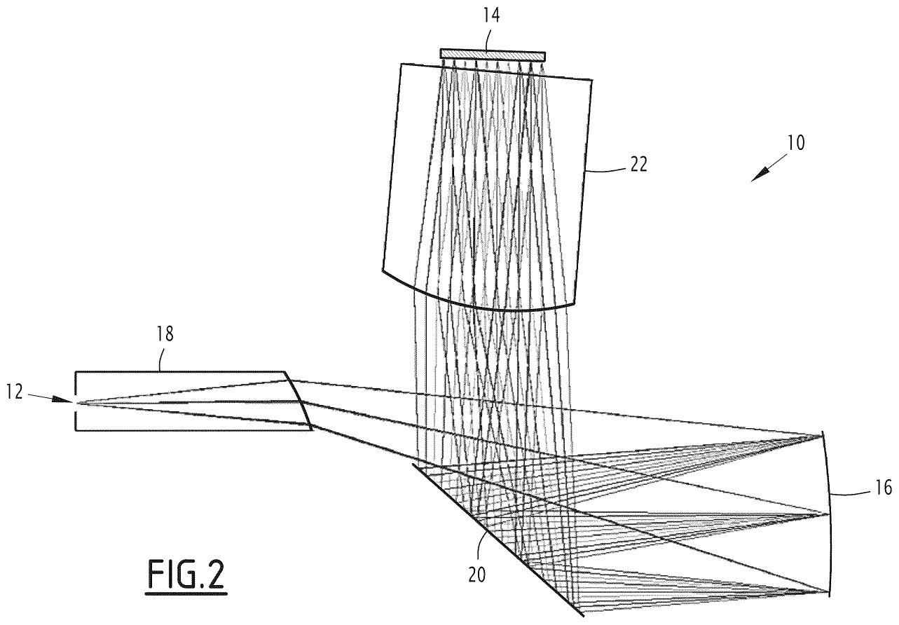

A spectrometer 10 is illustrated in FIG. 2.

As shown in the figure, the spectrometer 10 includes a slit 12, a detector 14, a diffraction grating 16, a collimating lens 18, a deflecting mirror 20 and a focusing lens 22.

Preferably, the collimating lens 18, the diffraction grating 16, the deflecting mirror 20 and the focusing lens 22 are the only optics of the spectrometer 10.

Moreover, the diffraction grating 16 is advantageously a reflection diffraction grating, as shown in FIG. 2.

The slit 12 is suitable for receiving a light beam. The slit 12 is, for example, less than or equal to 20 millimeters (mm) long, preferably less than or equal to 15 mm.

The light beam is, for example, in the visible range (e.g. 380 to 780 nm). Alternatively, the light beam may also extend into the ultraviolet range (100 to 380 nm) or infrared range (780 nm to 100 μm).

The detector 14 is able to detect a light beam arriving at the detector 14. In particular, the detector 14 is able to detect light spectra and measure light intensity as a function of wavelength.

The diffraction grating 16 is capable of diffracting an incident beam into a plurality of diffracted beams. The diffracted beams are spectrally separated.

Preferably, the diffraction grating 16 is spherical. For example, the diffraction grating 16 is engraved onto a spherical mirror.

Alternatively, the diffraction grating 16 is aspherical or made using freeform technology. Freeform optics have no axis or center of symmetry, allowing a greater number of degrees of freedom in optical design.

The collimating lens 18 is capable of sending the light beam from the slit 12 onto the diffraction grating 16 so as to obtain a plurality of diffracted beams.

Preferably, the collimating lens 18 is a spherical lens.

The deflecting mirror 20 is designed to reflect the plurality of diffracted beams.

The focusing lens 22 is designed to receive the plurality of diffracted beams reflected by the deflecting mirror 20 and to focus the plurality of diffracted beams on the detector 14.

At least one optic, referred to as an optimized optic, from among the collimating lens 18, deflecting mirror 20, and focusing lens 22, so as to improve the image quality of the image generated by the detector 14 from the plurality of diffracted beams. Improving image quality means reducing aberrations (compared to a non-optimized configuration).

Preferably, the or each optimized optic is a Freeform optic.

Preferably, the spectrometer 10 includes two optimized optics.

Preferably, at least one optimized optic is the deflecting mirror 20.

Preferably, at least one optimized optic is the focusing lens 22.

Thus, in a preferred embodiment:
the collimating lens 18 is a spherical lens;
the diffraction grating 16 is spherical;
the deflecting mirror 20 is Freeform, and
the focusing lens 22 is Freeform.

In this preferred mode, the slit 12 and the detector 14 are each preferably located close to the center of curvature of the collimating lens 18, the diffraction grating 16 and the focusing lens 22.

In this design, the deflecting mirror 20 mechanically separates the slit 12 and detector 14, and most importantly, by adding a Freeform surface, corrects the limiting aberrations (mainly astigmatism).

In one example embodiment, the collimating lens 18 and the focusing lens 22 have different powers so that the magnification of the spectrometer 10 is different from 1.

In one example embodiment, the powers of both the collimating 18 and focusing 22 lenses are chosen so that the magnification of the spectrometer 10 is between 0.2 and 5.

One example of a method for designing the spectrometer 10 will now be described. Such an optical design method is computer-implemented using an optical design tool. The optical design tool is, for example, Zemax software.

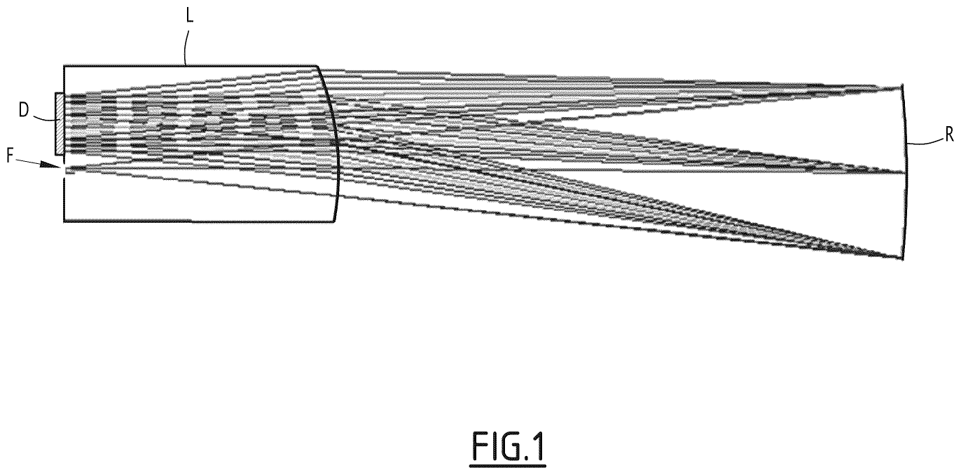

The design method includes an operation of loading a Dyson spectrometer, such as that shown in FIG. 1, into the optical design tool. Such a Dyson spectrometer includes:
a slit F suitable for receiving a light beam,
a detector D,
a diffraction grating R with at least one curvature, and
a double-pass lens L capable, on the one hand, of sending the light beam from the slit F onto the diffraction grating R so as to obtain a plurality of diffracted beams and, on the other hand, of focusing the plurality of diffracted beams onto the detector D.

The design method includes an operation of splitting the double-pass lens L so as to obtain:
a collimating lens 18 capable of sending the light beam from the slit F onto the diffraction grating R to obtain a plurality of diffracted beams, and
a focusing lens 22 capable of focusing the plurality of diffracted beams onto the detector D.

The design method includes the operation of adding a deflecting mirror 20. The addition operation may be carried out before the splitting operation, or the two operations may be carried out simultaneously.

The design method includes an operation of rearranging the collimating lens 18, focusing lens 22, and deflecting mirror 20 so as to spatially separate the slit F and the detector D and so that the deflecting mirror 20 is able to reflect the plurality of diffracted beams towards the focusing lens 22.

The design method includes an operation of optimizing at least one optic, referred to as an optimized optic, from among the collimating lens 18, deflecting mirror 20, and focusing lens 22, so as to improve the image quality of the image generated by the detector D from the plurality of diffracted beams.

As explained above, the optimized optics are, for example, Freeform optics. The optimized optic(s) is/are preferably the deflecting mirror 20 and/or the focusing lens 22.

The design method includes an operation of rearranging the slit F, the detector D, the diffraction grating R, the collimating lens 18, the focusing lens 22 and the deflecting mirror 20 to obtain a mechanically adjustable spectrometer 10.

By virtue of its configuration, the spectrometer 10 does not necessarily require a freeform grating (the grating may be spherical or aspherical, for example), while remaining compact like a Dyson and offering good image quality. In particular, the image quality (particularly astigmatism) is corrected by the position of the slit F. The resulting trefoil is corrected by modifying the focusing lens 22 (which becomes different from the collimating lens 18).

In particular, simulations have been carried out for the preferred embodiment in which the collimating lens 18 is a spherical lens, the diffraction grating 16 is spherical, the deflecting mirror 20 is Freeform and the focusing lens 22 is freeform. These simulations show that imaging quality is improved by 60% compared with a current Dyson spectrometer.

Such a spectrometer 10 also makes it possible to separate the slit and the detector, which facilitates the mechanical integration of the different elements, and in particular that of the detector with its electronics.

Finally, an interesting variation may be obtained by separating the collimating and focusing lenses: the spectrometer's magnification may differ from 1. Indeed, the symmetry associated with the magnification of 1 and the construction of the Dyson with a common center of curvature mean that certain aberrations (spherical aberrations, coma, Petzval curvature) may be naturally eliminated. By breaking this symmetry and the magnification of 1, the solution becomes less favorable for correcting aberrations. However, the gain brought about by the freedom of the slit and the position of the focusing lens 22 means that it is possible to depart from a magnification of 1 while still maintaining an attractive image quality. This would not have been possible with a traditional Dyson or Freeform grating Dyson solution.

The choice of modifying the magnification (within a range of x0.2-x5) may be very useful in the overall design of the telescope and spectrometer. Usually, the only way to achieve this magnification while remaining relatively compact is to use an Offner spectrometer, which is not as compact as a Dyson.

Such a spectrometer may be used for many hyperspectral applications. This type of spectrometer is particularly suitable for use on a satellite in “push broom” mode. In particular, because it is so compact, the spectrometer 10 may be mounted on small satellites. Optical instruments that may image a scene in a plurality of spectral domains are known as hyperspectral instruments (for example, imaging a visible scene in 100 spectral domains 4 nm wide). This may lead to a wide range of information being extracted, such as unmasking military targets, determining the chemical composition of soil, isolating vegetation, determining the chemical composition of oceans, or determining the amount of plastic pollution in oceans or rivers.

The skilled person will appreciate that the above-described embodiments and variants may be combined to form new embodiments, provided that they are technically compatible.

1. A spectrometer comprising:
a slit suitable for receiving a light beam;
a detector;
a diffraction grating with at least one curvature;
a collimating lens capable of sending the light beam from said slit onto said diffraction grating so as to obtain a plurality of diffracted beams;
a deflecting mirror capable of reflecting the plurality of diffracted beams; and
a focusing lens designed to receive the plurality of diffracted beams reflected by said deflecting mirror and to focus the plurality of diffracted beams on said detector,
wherein at least one optic, referred to as an optimized optic, from among said collimating lens, said deflecting mirror, and said focusing lens, improves the image quality of the image generated by said detector from the plurality of diffracted beams.

2. The spectrometer according to claim 1, wherein said collimating lens, said diffraction grating, said deflecting mirror and said focusing lens are the only optics of the spectrometer, said diffraction grating being comprising a reflection diffraction grating.

3. The spectrometer according to claim 1, wherein the or each optimized optic is a freeform optic.

4. The spectrometer according to claim 1, comprising two optimized optics.

5. The spectrometer according to claim 1, wherein at least one optimized optic is said deflecting mirror.

6. The spectrometer according to claim 1, wherein at least one optimized optic is said focusing lens.

7. The spectrometer according to claim 1, wherein said collimating lens comprises a spherical lens.

8. The spectrometer according to claim 1, wherein said diffraction grating is spherical.

9. The spectrometer according to claim 1, wherein said collimating lens and said focusing lens have different powers so that the magnification of the spectrometer is different from 1.

10. The spectrometer according to claim 1, wherein the powers of both said collimating lens and said focusing lens are chosen so that the magnification of the spectrometer is between 0.2 and 5.

11. A method for optically designing a spectrometer according to claim 1, the method being computer-implemented by means of an optical design tool, the method comprising:
loading, into the optical design tool, a Dyson spectrometer comprising a slit suitable for receiving a light beam, a detector, a diffraction grating with at least one curvature, and a double-pass lens capable, on the one hand, of sending the light beam from the slit onto the diffraction grating so as to obtain a plurality of diffracted beams and, on the other hand, of focusing the plurality of diffracted beams onto the detector;
splitting the double-pass lens to obtain a collimating lens sending the light beam from the slit onto the diffraction grating to obtain a plurality of diffracted beams, and a focusing lens focusing the plurality of diffracted beams onto the detector;
adding a deflecting mirror;
rearranging the collimating lens, focusing lens, and deflecting mirror so as to spatially separate the slit and the detector and so that the deflecting mirror is able to reflect the plurality of diffracted beams towards the focusing lens;
optimizing at least one optic, referred to as an optimized optic, from among the collimating lens, the deflecting mirror, and the focusing lens, so as to improve the image quality of the image generated by the detector from the plurality of diffracted beams; and
rearranging the slit, the detector, the diffraction grating, the collimating lens, the focusing lens and the deflecting mirror to obtain a mechanically adjustable spectrometer.
